(19) United States
(12) Patent Application Publication
(10) Pub. No.: US 2004/0057250 A1
(43) Pub. Date: Mar. 25, 2004

(54) Xenon short-arc lamp with fiberoptic filters

(75) Inventors: Roy D. Roberts, Hayward, CA (US); Kevin Tong, San Jose, CA (US); Michael H. Iguchi, Mountain View, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: PerkinElmer Optoelectronics N.C., Inc.

(21) Appl. No.: 10/253,271

(22) Filed: Sep. 23, 2002

(51) Int. Cl. F21V 7/04; F21V 29/00; F21V 9/00

(52) U.S. Cl. 362/554; 362/583; 362/293; 362/294

(57) ABSTRACT

A fiberoptic-driving ceramic arc lamp system comprises a ceramic arc lamp fitted with as many as three filters attached to the lamp unit and its heat sinks. A heat-collecting ring is nested into matching groves in the front of the lamp unit and is thermally connected to the lamp's heatsinks and cooling system. A hot mirror is disposed in the heat-collecting ring nearest the lamp unit's window. Such mirror is coated on its near side with IR reflecting materials and is coated on its distal side with UV reflecting materials. A heat-absorbing glass is also disposed in the heat-collecting ring after the hot mirror. It collects more of the IR that was missed by the hot mirror and disperses it as heat through the cooling system. The remaining light can then be focused onto the input end of a fiberoptic bundle without danger of overheating and melting the fiberoptic materials.

### BACKGROUND OF THE INVENTION

1. Field of the Invention

The invention relates generally to xenon short-arc lamps, e.g., so-called ceramic arc lamps, and more specifically to lamps and assemblies that incorporate infrared filters to control melting of the input ends of fiberoptic bundles used to pipe the light output.

2. Description of the Prior Art

Xenon short-arc lamps provide intense point sources of light that collect their light in reflectors for applications in medical endoscopes, instrumentation, video projection, and industrial endoscopes, for example in the inspection of jet engine interiors. More recent applications have been in color television receiver projection systems and dental curing markets.

A typical short-arc lamp comprises an anode electrode and a sharp-tipped cathode positioned along the longitudinal axis of a cylindrical, sealed concave chamber that contains xenon gas pressurized to several atmospheres. U.S. Pat. No. 5,721,465, issued Feb. 24, 1998, to Roy D. Roberts, describes such a typical short-arc lamp. These are marketed under the brand name CERMAX xenon illuminators by ILC Technology (Sunnyvale, Calif.), now a part of Perkin-Elmer Optoelectronics, Inc.

The natural spectral power output distribution of xenon short-arc lamps spans the ultraviolet (UV) wavelengths of 200-400 nanometers (nm), the visible light wavelengths of 400-680 nm, and the infrared (IR) wavelengths of 680-5000 nm. A large portion of the total power output is in the IR band. The powerful UV and IR radiation from such lamps can cause skin burns and eye damage. UV radiation can also generate ozone. So depending on the final application of use, these extreme wavelengths are often filtered out by combinations of color filters that absorb a selected energy, and hot/cold mirrors that reflect a chosen energy.

In dental curing applications, the raw light output of the lamp must be filtered to cut off both the UV and IR wavelengths and some of the visible. Typically the 420-500 nm band is preferred. Flexible light pipes of fiberoptic bundles are typically used to channel the lamp output to the point of application. If the IR wavelengths from the lamp entering the fiberoptic bundle are too intense, the input end is subject to melting because too much IR heat is absorbed.

### SUMMARY OF THE PRESENT INVENTION

It is therefore an object of the present invention to manage the IR radiation produced by ceramic arc lamps to prevent overheating and burning of fiberoptic bundles that conduct the useful light away to a point of application.

It is another object of the present invention to provide a ceramic arc lamp for fiberoptic uses that is simple and compact.

Briefly, a fiberoptic-driving ceramic arc lamp system embodiment of the present invention comprises a ceramic arc lamp fitted with as many as three filters attached to the lamp unit and its heat sinks. A heat-collecting ring is nested into matching groves in the front of the lamp unit and is thermally connected to the lamp's heatsinks and cooling system. A hot mirror is disposed in the heat-collecting ring nearest the lamp unit's window. Such mirror is coated on its near side with IR reflecting materials and is coated on its distal side with UV reflecting materials. A heat-absorbing glass is also disposed in the heat-collecting ring after the hot mirror. It collects more of the longer-wavelength IR that was missed by the hot mirror and disperses it as heat through the cooling system. The remaining light can then be focused onto the input end of a fiberoptic bundle without danger of overheating and melting the fiberoptic materials.

An advantage of the present invention is that an illumination system is provided that prevents destruction of its own fiberoptic bundles.

Another advantage of the present invention is that an illumination system is provided for dental blue curing applications.

These and other objects and advantages of the present invention will no doubt become obvious to those of ordinary skill in the art after having read the following detailed description of the preferred embodiments which are illustrated in the drawing figures.

### IN THE DRAWINGS

FIG. 1 is cross sectional view of a fiberoptic and xenon short-arc lamp system embodiment of the present invention; and

FIG. 2 is cross sectional view of an arc lamp and filter holder/cooling-ring assembly similar to that of FIG. 1.

### DETAILED DESCRIPTION OF THE PREFERRED EMBODIMENT

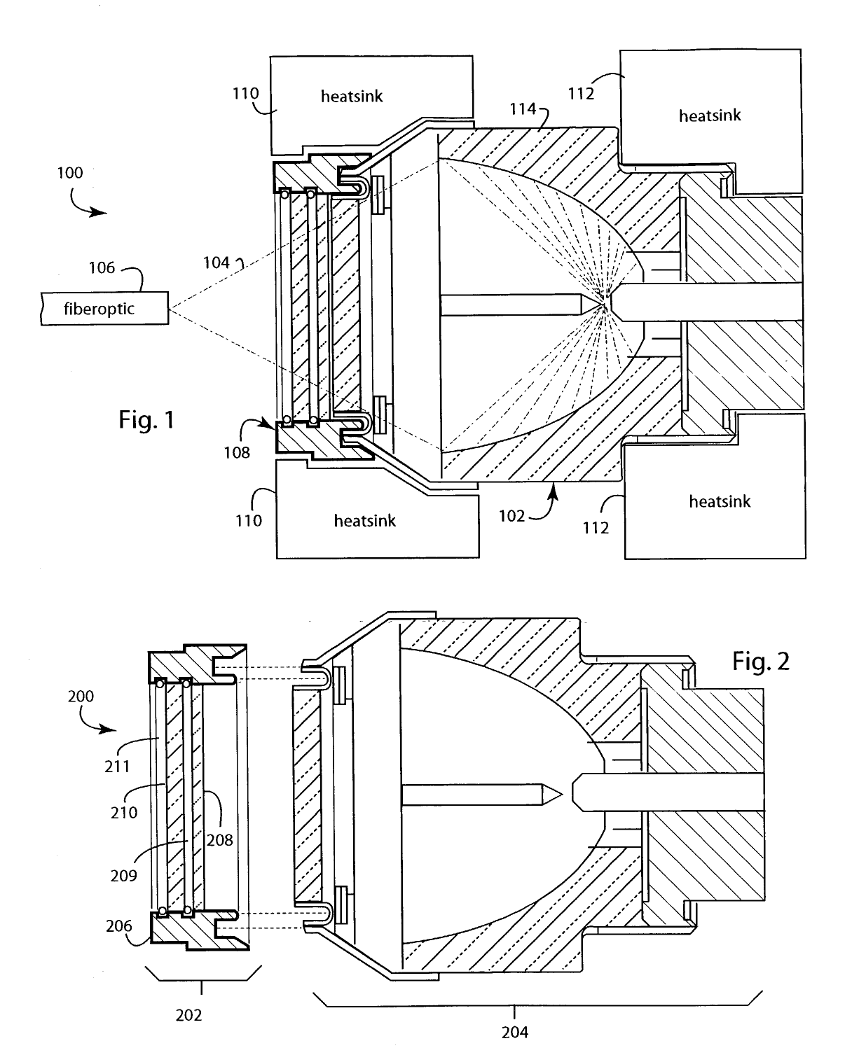

FIG. 1 illustrates a fiberoptic and xenon short-arc lamp system embodiment of the present invention, and is referred to herein by the general reference numeral 100. The system 100 comprises a ceramic arc lamp 102 that focuses a beam of light 104 into the input end of a fiberoptic bundle 106. The constituent wavelengths of light included in the beam of light 104 are controlled by a hot mirror/filter assembly 108 to limit dangerous, destructive, and harmful infrared (IR) and ultraviolet (UV) radiation that reach the fiberoptic bundle 106. In particular, the high power output of lamp 102 in the IR band is enough to melt or deteriorate the fiberoptic bundle 106 if left unchecked. A cathode heatsink 110 and an anode heatsink 112 are used to cool a ceramic lamp body 114 and the hot mirror/filter assembly 108.

FIG. 2 shows a lamp and filter assembly 200 that is similar to ceramic arc lamp 102 and hot mirror/filter assembly 108. A hot mirror/filter assembly 202 is shown detached from a ceramic arc lamp 204. A filter holder and cooling ring 206 carries a hot mirror 208 and a heat-absorbing filter 210. A split-ring spacer 209 is typically used to separate hot mirror 208 and heat-absorbing filter 210 and keep them in position. Another split-ring spacer 211 retains the heat-absorbing filter 210 in the cooling ring 206. The glass optics in lamp and filter assembly 200 preferably are comprised of glass, fused-silica, quartz, and/or synthetic sapphire.

The side of hot mirror 208 nearest lamp 204 is preferably coated with a material that will reflect IR radiation and pass through visible and UV radiation. For example, wavelengths longer than about 680 nm are reflected. In alternative embodiments of the present invention, side of hot mirror 208 toward filter 210 is coated with a material that will reflect UV radiation and pass through visible and IR radiation. In this case, wavelengths shorter than 400 nm are reflected back toward lamp 204. The heat-absorbing filter 210 blocks passage of IR radiation with wavelengths longer than about 1200 nm. The energy is absorbed and carried away as heat by filter holder and cooling ring 206 and any cathode heatsink, e.g., cathode heatsink 110 in FIG. 1.

Commercially available filters that pass wavelengths 420-500 nm allow for IR blocking as well. For example, products like the HEATBUSTER model DS-3600, dental blue curing filters marketed by Deposition Sciences Incorporated (Santa Rosa, Calif.) can be used for hot mirror 208.

The longer IR wavelengths would be felt as heat in sensitive tissues by a dental patient if passed on by the lighting system. The dental blue curing filters can be applied directly to the lamp cover window surfaces, as well as the glass optics connecting the fiberoptics to the light source.

The heat-absorbing filter 210 preferably absorbs IR wavelengths longer than 1200 nm. For example, such filter can be implemented with a Melles Griot (Irvine, Calif.) KG4 Schott glass type heat absorbing filter, e.g., part number 03-FCG-569.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A fiberoptic illumination system, comprising:
a ceramic arc lamp;
a first glass optic including a hot-mirror coating and disposed to reflect back infrared radiation from the ceramic arc lamp with wavelengths about 680-1200 nm;
a second glass optic including a heat absorbing filter of disposed to absorb any remaining infrared radiation from the ceramic arc lamp with wavelengths longer than about 1200 nm that pass through the first glass optic; and
a fiberoptic bundle positioned to receive light from the ceramic arc lamp that has passed through both the first and second glass optics;
wherein, the amount of infrared radiation from the ceramic arc lamp that reaches the fiberoptic bundle is attenuated enough to prevent heat damage to the fiberoptic bundle.

2. The system of claim 1, further comprising:
a UV-reflective coating disposed on a surface of the first glass optic on a side toward the second glass optic and for providing attenuated ultraviolet radiation with wavelengths shorter than about 400 nm from reaching the fiberoptic bundle.

3. The system of claim 1, wherein:
the first glass optic is such that said hot-mirror coating is disposed on a side nearest the ceramic arc lamp.

4. The system of claim 1, further comprising:
a filter holder and cooling ring assembly in which the first and second glass optics are disposed and providing for a thermal connection to the ceramic arc lamp for cooling and mechanical support.
